(19) United States
(12) Patent Application Publication
(10) Pub. No.: US 2002/0087962 A1
(43) Pub. Date: Jul. 4, 2002

(54) System and process for migrating enhancements to a system

(76) Inventors: Charles A. Hudson, Richmond, VA (US); Brock McDonald, Richmond, VA (US); James Hutchinson, Richmond, VA (US); Catherine M. Atkins, Richmond, VA (US); Donald Kilby, Chesterfield, VA (US); Rosalind Joy Cheeseman, Richmond, VA (US)

Correspondence Address: Hunton & Williams, 1900 K Street, N. W., Washington, DC, 20006-1109, US

(21) Appl. No.: 09/749,941

(22) Filed: Dec. 29, 2000

(51) Int. Cl. G06F 9/445

(52) U.S. Cl. 717/172; 717/173

(57) ABSTRACT

A system and process for migration enhancements to software located on a model or production system are described. When enhancements are received, a trigger file(s) is created. An archive copy of the model or production system is saved, including the portion of the model or production system where the enhancements are to be migrated. The enhancements are migrated based on the trigger file, thereby enabling the enhancements to be automatically migrated. The archived copy is reinstalled if the enhancements are not properly installed. If the enhancements are properly installed, the system is tested. The invention may enable migration to occur when the model or production system is used least by its users.

### FIELD OF THE INVENTION

The present invention relates to a system and process for migrating enhancements to software located on a model or production system, and more particularly to a system and process for migrating enhancements during off-peak hours to avoid conflict with the use of the model or production system.

### BACKGROUND OF THE INVENTION

Computer software systems are prevalent in almost all facets of modern life. Many businesses, such as financial service providers, Internet web sites, and shipping companies, just to name a few, rely on computer software systems for day to day activities. Often, computer software systems (or “software systems”) may dynamically evolve, where functions of the software systems are added, deleted, or modified to provide one or more enhancements for users of the software system.

A difficulty associated with such enhancements may include ensuring that all necessary program modules within a software system have been modified appropriately. By way of example, adding a new function to a software system may require modifying three program modules within the software system. Failure to modify all three program modules may result in the function and/or the entire software system not being able to operate.

Another difficulty may involve migrating one or more enhancements into a model or production system without interfering with the use of the system. Most users of a model or production system will use the system during daytime hours. Employees charged with migrating enhancements may also work during daytime hours, thereby leading to interference with the model or production system.

Other drawbacks may also exist.

### SUMMARY OF THE INVENTION

It is therefore desirable that the invention overcome these and other drawbacks of present systems and methods.

There is a particular need for a system and process for enabling the migration of enhancements into a model or production system without interfering with the use of the model or production system.

It is also desirable to provide a system and process for migrating enhancements into a model or production system without active participation of a person and during a time when the model or production system is in minimal use.

Thus, there is need to provide a system and process for managing acceptance of migration strategies within a system. To achieve this invention, as embodied and broadly described herein a process for migrating one or more enhancements into a system is provided, where the system comprises one or more program modules and where an enhancement comprises at least one of modifying one or more program modules and adding one or more program modules, and where the process comprises the steps of receiving one or more enhancements from a developer; generating at least one trigger file associated with the one or more enhancements, where the at least one trigger file is generated based on the information associated with the one or more enhancements and the trigger file includes instructions for migrating the enhancements and the one or more enhancements; migrating the one or more enhancements into the system based at least in part on the generated at least one trigger file; and receiving an indication of whether the step of migrating the one or more enhancements was successful.

In another aspect of the invention, a process for migrating one or more enhancements into a system is provided, where the system comprises one or more program modules and where an enhancement comprises at least one of modifying one or more program modules and adding one or more program modules. The process comprises the steps of receiving one or more enhancements from a developer; generating at least one trigger file to be associated with each of the one or more enhancements, wherein the at least one trigger file is generated based on information associated with the one or more enhancements and the trigger file includes instructions for migrating the enhancements and the one or more enhancements; archiving a copy of at least a portion of the system, where the at least a portion of the system includes the portion of the system to be modified by the at least one enhancement; migrating the one or more enhancements into the system based at least in part on the generated at least one trigger file; and receiving an indication of whether the step of migrating the one or more enhancements was successful.

In another aspect, a system for migrating one or more enhancements into a model or production system is provided, where the model or production system comprises one or more program modules and where an enhancement comprises at least one of modifying one or more program modules and adding one or more program modules. The system comprises a receiver module for receiving one or more enhancements from a developer; a processor module for generating at least one trigger file associated with the one or more enhancements, where the at least one trigger file is generated based on information associated with the one or more enhancements and the trigger file comprises instructions for migrating the enhancements and the one or more enhancements; and a migration module for migrating the one or more enhancements into the system based at least in part on the generated at least one trigger file; and where the receiver module receives an indication of whether the step of migrating the one or more enhancements was successful.

In a further aspect, a system for migrating one or more enhancements into a model or production system is provided, where the model or production system comprises one or more program modules and where an enhancement comprises at least one of modifying one or more program modules and adding one or more program modules. The system comprises a receiver module for receiving one or more enhancements from a developer; a processor module for generating at least one trigger file to be associated with each of the one or more enhancements, where the at least one trigger file is generated based on the information associated with the one or more enhancements and the trigger file comprises instructions for migrating the enhancements and the one or more enhancements; an archiving module for archiving a copy of at least a portion of the system, where the at least a portion of the system includes the portion of the system to be modified by the at least one enhancement; a migration module for migrating the one or more enhancements into the system based at least in part on the generated at least one trigger file; and where the receiver module receives an indication of whether the migrating of the one or more enhancements was successful.

The accompanying drawings, which are incorporated in and constitute a part of this specification, illustrate an embodiment of the invention and, together with the description, serve to explain the principles of the invention.

### BRIEF DESCRIPTION OF THE DRAWINGS

FIGS. 1-4 disclose a flowchart illustrating steps in a process of migrating one or more enhancements of a software application into a model or production software system according to an embodiment of the invention.

FIGS. 5 and 6 discloses a flowchart illustrating steps in a process for change management according to an embodiment of the invention.

FIG. 7 is a schematic representation of a system for implementing one or more of the processes described according to an embodiment of the invention.

### DETAILED DESCRIPTION OF THE INVENTION

Reference will now be made in detail to the present preferred embodiment of the invention, an example of which is illustrated in the accompanying drawings in which like reference characters refer to corresponding elements.

TOUCH-LESS MIGRATION PROCESS (TMP)

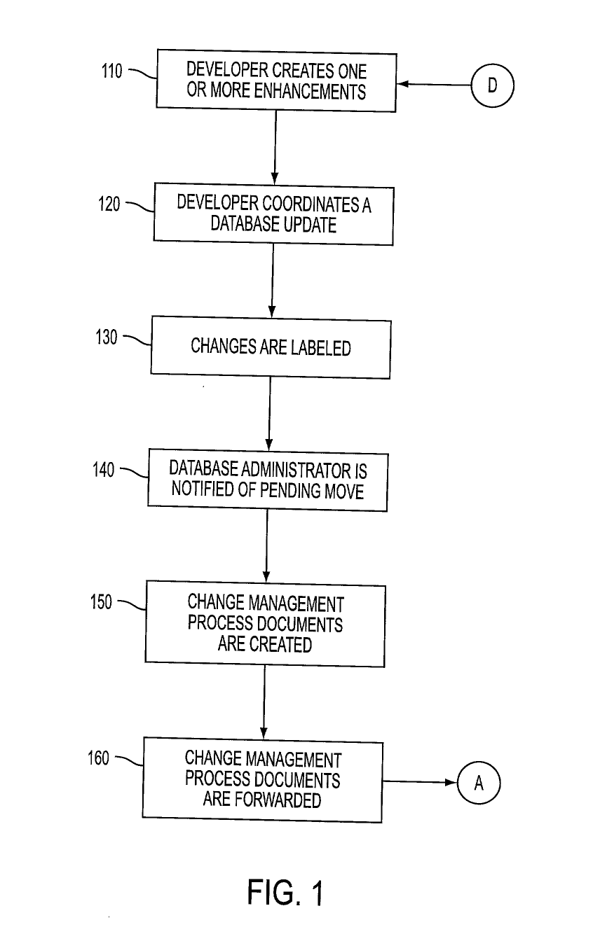

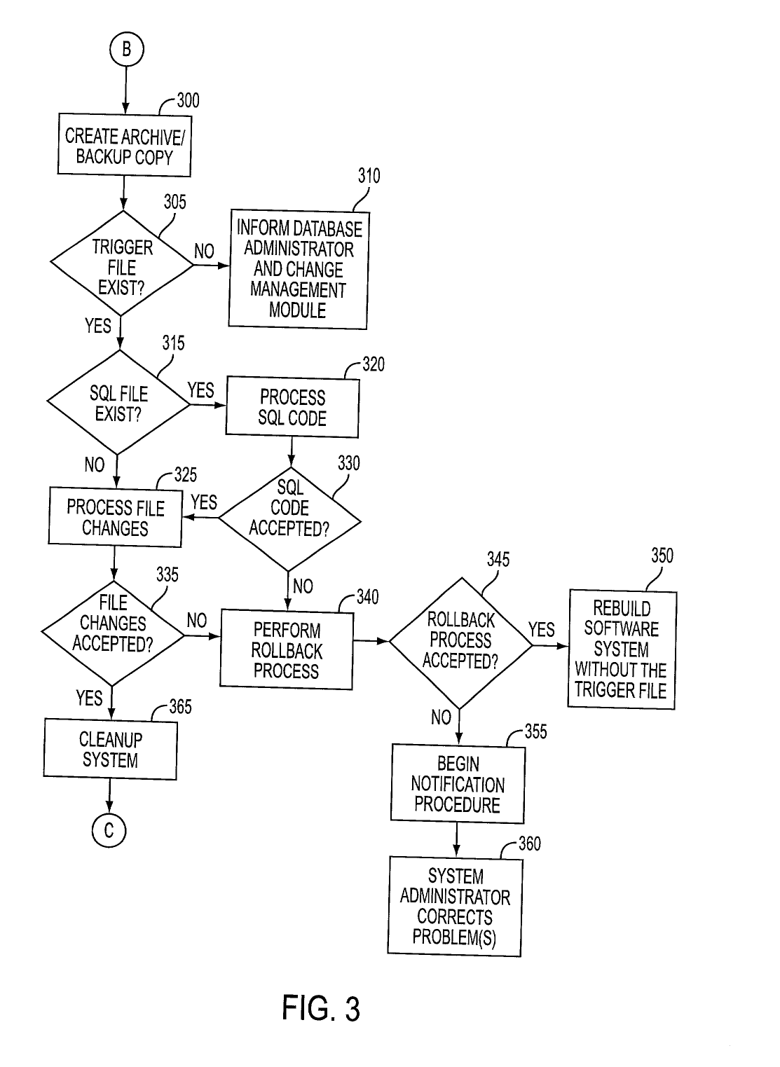

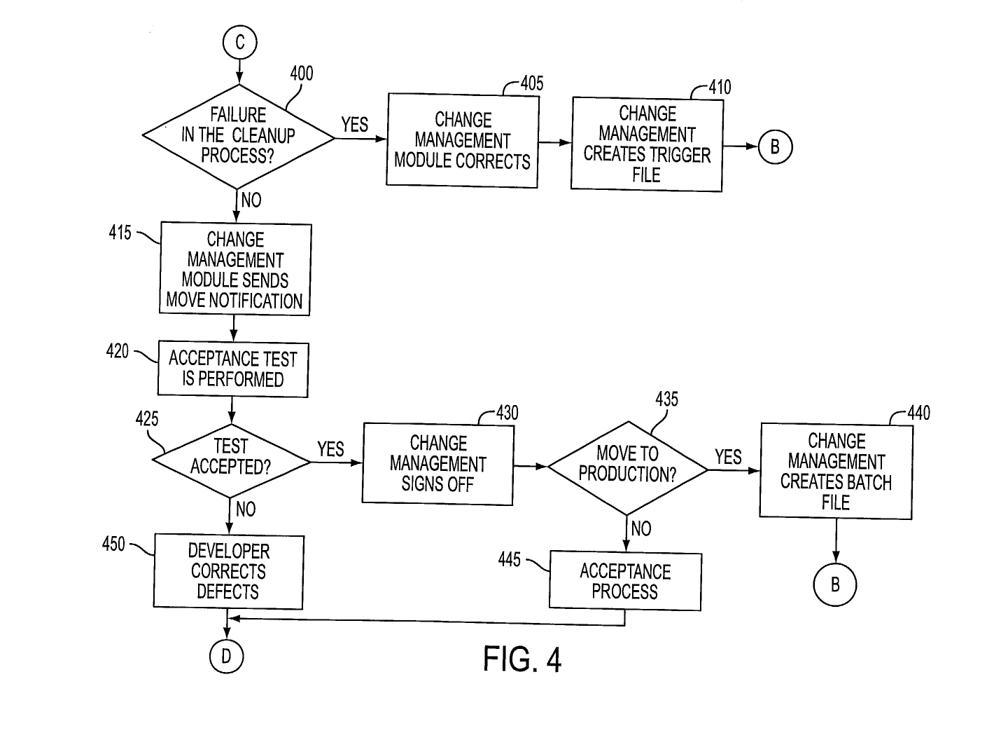

The present invention relates to a system and process for migrating one or more enhancements of software located on a model or production system. Once the development of the enhancements is completed, one or more trigger files is generated to aid in the migration of the enhancements into the system. A copy of the initial model or production system is archived and the one or more enhancements are migrated into the model or production system. The system is then tested for the success of the migration. If the migration is unsuccessful, the model or production system is restored to its original status based on the archived copy and the enhancements are returned to the developers to be corrected. According to an embodiment of the invention, enhancements may be migrated into the model or production system at a time when there is low usage of the model or production system (e.g., during late night or early morning hours). Successful migrations into the model or production system may then be tested to ensure that the desired functionalities of the model or production system are obtained. If the testing is unsuccessful, the one or more enhancements may be returned to the developer for correction. The original model or production system may be restored using the archived copy. The touchless migration process of the present invention will now be described in greater detail below with reference to FIGS. 1-4.

As shown in FIG. 1, at step 110, a developer creates one or more enhancements for a model or production system. According to an embodiment of the invention, a model or production system may comprise one or more program modules which effectuate functions of the model or production system. An enhancement may comprise modifying one or more program modules of a software system and/or creating one or more new program modules for the model or production system.

At step 120, the developer may coordinate a database update with a database administrator. Coordinating the update may include determining a schedule for moving one or more enhancements into the database or other updates and then proceeding to make source code changes, scheduling changes, output distribution changes, operator instructions or special instructions. At step 130, a source control tool may be used to label changes to applications resulting from the one or more enhancements. Labeling changes may include indicating a version of a changed application function or other aspect of the model or production system. According to an embodiment of the invention, a third party software package, such as Poly Version Control Software, marketed by Merant, Inc. (PVCS), may be used to label such changes.

At step 140, the database administrator is notified of the pending move. A change management process document such as an Electronic Change Management Process (ECMP) is created and includes the database move date at step 150. As described below, the change management process document may contain information needed by a change management module to perform the functions of migrating the one or more enhancements into the model or production system.

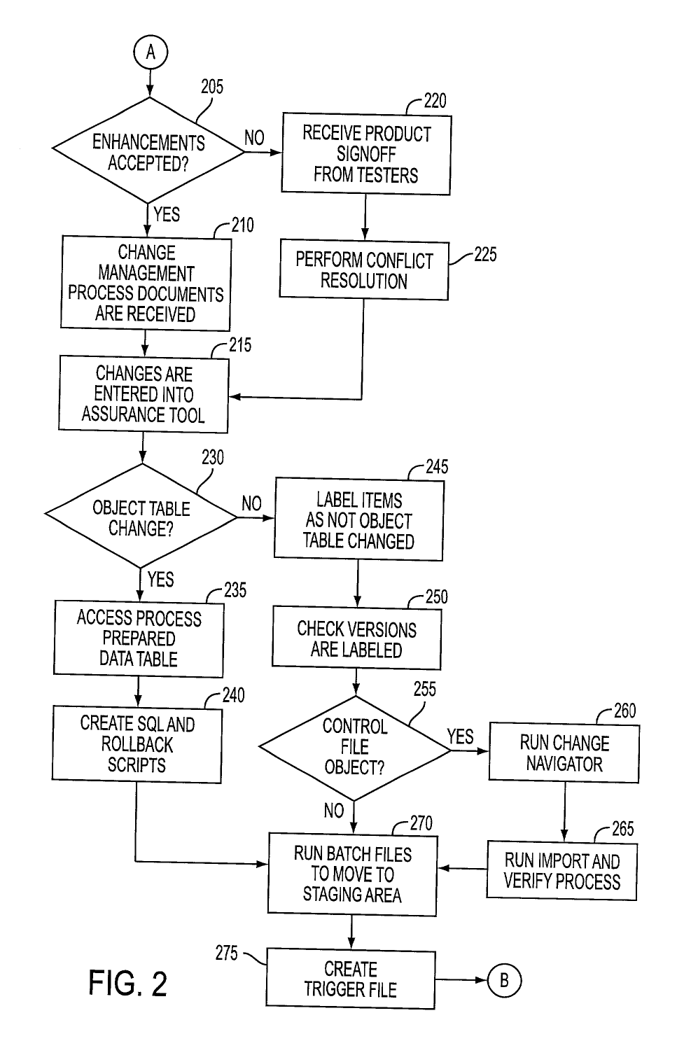

At step 160, a change management process document and any related request for services (RFS) are forwarded to a change management module. At step 205 (see FIG. 2), the change management module determines whether the one or more enhancements have been accepted. If an acceptance test has already been performed, the change management module receives the change management process documents (e.g., the electronic change management process document) and any related RFSs at step 210. At step 215, changes are entered into an assurance tool. According to an embodiment of the invention, an assurance tool may be used to determine whether conflicts exist within the one or more enhancements or program modules associated with the one or more enhancements. By way of example, an enhancement to a database entry field may conflict with a change to a database sorting feature. Use of an assurance tool may assure that these conflicts are resolved before migration occurs.

If acceptance testing has not been performed on the one or more enhancements, the change management module may receive a product sign-off from testers at step 220. The testers may perform one or more predetermined tests on one or more enhancements to determine the acceptability of the enhancements. Conflict resolution may be performed at step 225. Conflict resolution may include, but is not limited to, conflicts in system code or conflicts with other functional system elements which are not programmatically linked which may need to be simultaneously migrated to provide the desired outcome in the model or production system. When conflict resolution has been performed for the one or more enhancements, the changes are entered into an assurance tool with the database change note at step 215 as described in greater detail above.

At step 230, a determination is made as to whether an object table change is to be made. If an object table change is to be made, a process prepare data table is accessed at step 235. The process prepare data table may include, but is not limited to, entries which control policy forms, state regulatory approvals, document control parameters, etc. Using a structured query language (SQL), a command script and a roll-back script are used to alter the data table. According to an embodiment of the invention, the scripts may comprise detailed instructions indicating how all changes will be technically migrated into the model or production software system.

If no object table change is to be made at step 230, various items are labeled as not having an object table change at step 245. These items may include documents, scripts, programs or program modules, menus, data dictionaries, control files or other items that are related to one or more enhancements, one or more program modules and/or one or more production systems. Versions of these items may be checked out at step 250 and labeled according to various modules. According to an embodiment of the invention, the items may be labeled according to the PVCS source control tool. At step 255, a determination is made whether there are control file objects. If control file objects are present, a software management utility is run at step 260. According to an embodiment of the invention, the software management utility may be Change Navigator, developed and marketed by Trimark Technologies, and used to import and export programs. At step 265, an import language, such as MAGIC, is run and the process is verified. If no control file object language is present, run batch files which contain any changes for migration are moved to a staging area at step 270. According to an embodiment of the invention, a staging area may be a data storage module for storing the files.

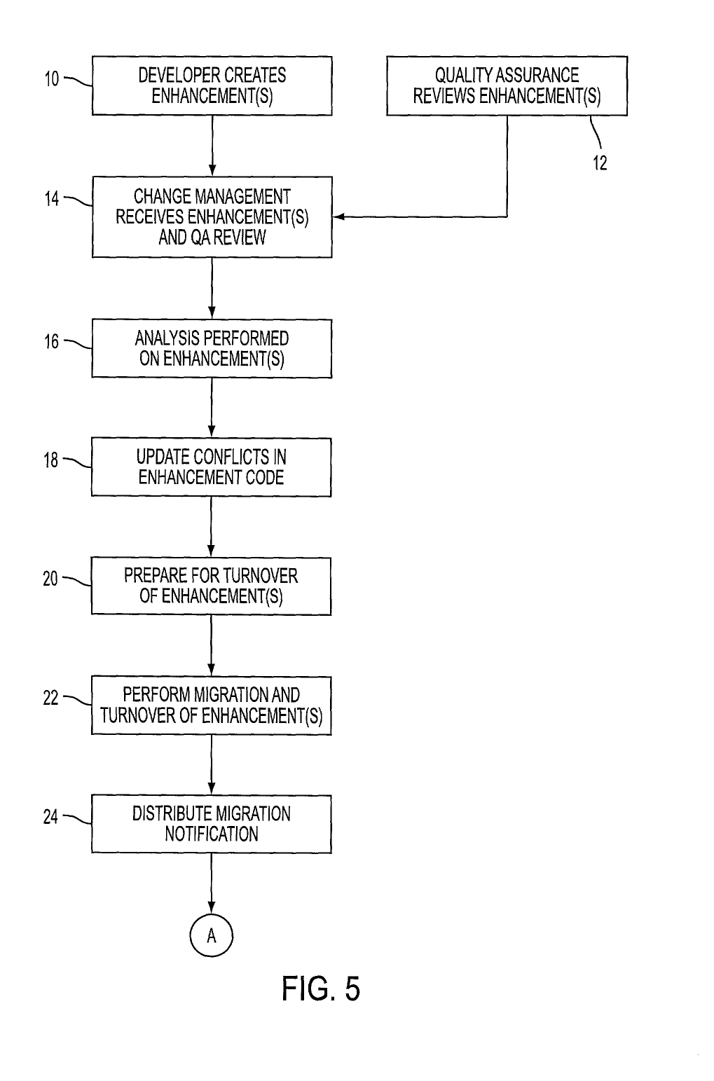

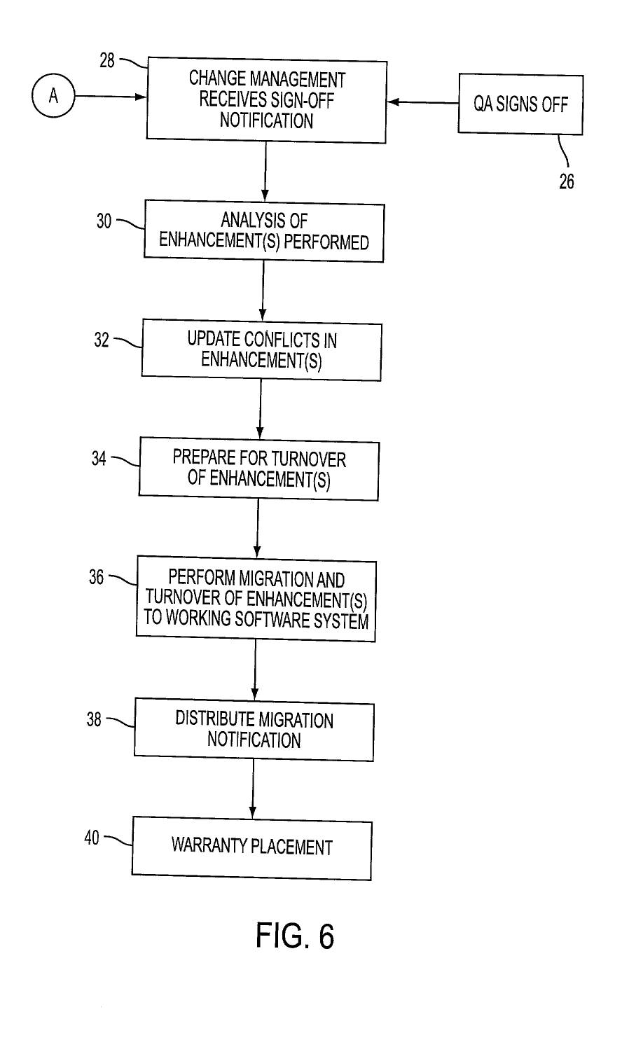

At step 275, one or more trigger files are created for the one or more enhancements. According to an embodiment of the invention, a separate trigger file may be created for each enhancement. A trigger file may comprise information related to the enhancement, including instructions for migrating the enhancement, a schedule for migrating the enhancement, an identification of the software system to receive the migration, and the enhancement itself and an indicator of the target system, whether model or production. Thus, according to an embodiment of the invention, the process may be used for a migration into a model software system and/or a migration into a production software system. Migration of one or more enhancements into a model software and a production software system are described below in greater detail with reference to FIGS. 5 and 6. The trigger file may be stored in a storage device (e.g., a database, an optical disc, etc.).

At step 300, the model or production software system is copied and archived, such as by an archive module. It is understood that, as different types of models or production systems may receive different enhancements, archived copies of each system may need to be made. At the time of migration (e.g., when the system is used the least), a determination is made as to whether a particular trigger file exists at step 305. According to an embodiment of the invention, where a migration module migrates the one or more enhancements in the model or production system, the migration module may look for one or more trigger files every evening at a predetermined time (e.g., 11:00 PM). If no trigger file exists, a database administrator and a change management module may be informed at step 310. The absence of a trigger file indicates that there are no changes to be migrated for the current schedule.

If a trigger file exists, a determination is made as to whether a structured query language (SQL) file(s) is present at step 315. If an SQL file(s) exists, the SQL code is processed at step 320, and a determination is made of whether the processed file is approved at step 330. According to an embodiment of the invention, a migration module processes the SQL file(s) by migrating the SQL file(s), and that portion of the one or more enhancements associated with SQL file(s), into the model or production system. According to an embodiment of the invention, determining whether a processed SQL file(s) is approved may include determining whether any errors resulted from processing the SQL file(s), whether the processed file properly functions, and other manners of approving a processed file.

If the processed SQL file(s) is approved, or if no SQL file is present, file changes are processed at step 325. According to an embodiment of the invention, all file changes may be processed at this step, where processing the file change(s) may include a migration module migrating the file change(s), and that portion of the one or more enhancements associated with file change(s), into the model or production system. A determination is then made as to whether the processed file changes are approved at step 335. As above with respect to the processed SQL file(s), determining whether a processed file change is approved may include determining whether any errors resulted from processing the file changes, whether the processed file functions properly, and other manners of approving a file.

If the processed file change(s) are not approved, or if the processed SQL file(s) are not approved, a rollback process may occur at step 340, where others are informed of the rollback process. According to an embodiment of the invention, a rollback process may involve reversing the migration of the SQL file(s) and/or file change(s), and the one or more enhancements associated with the SQL file(s) and/or file change(s), from a model or production system. At step 345, a determination is made of whether the rollback process was successfully performed. If the rollback was successful, the model or production system may be restored at step 350. According to an embodiment of the invention, the model or production system is restored to an original status based on an archived version of the model or production system copied before the various file(s) and associated enhancements are processed and migrated into the model or production system. The archived version may be copied at an earlier step which precedes the TMP process.

If the rollback process was not successful, a notification procedure is followed at step 355. According to an embodiment of the invention, if the rollback was not successful, one or more individuals, entities, departments, and/or other designated recipients receive notification that the rollback was not successful. By way of example, a technical support department may receive a notification, as well as all users of the model or production system. At step 360, a system administrator corrects any problems associated with the rollback process. By way of example, the system administrator may be part of a technical support department that receives notification that the rollback process was not successful. Other manners for reinstalling the original model or production system may also be used.

If the processed file change(s) are approved at step 335, the model or production system may be cleaned up to ensure that all functions are performing in a required fashion. According to an embodiment of the invention, a clean up process may include determining the condition of the code, debugging the code and eliminating errors where applicable, generating statistics related to the migration (e.g., the number of enhancements successfully migrated, the number of enhancements for which migration was attempted, the success percentage, etc.), performing diagnostic procedures, sending results of the diagnostic procedures, and other features to ensure the use of the model or production system by its users. Further, if the process file change(s) is approved, a notification may be sent to the change management module for a move notification distributed to users and developers.

At step 400, a determination is made as to whether there was any failure in the clean up process. If a failure occurs, a change management module may facilitate correction at step 405. According to an embodiment of the invention, a change management module may facilitate a correction by actually correcting the model or production system, the one or more enhancements, the file change(s), the SQL file(s), and/or other portions that are related to the specific failure. According to another embodiment of the invention, the change management module may forward the appropriate portions to others to facilitate correction of a failure. By way of example, if a particular file change for an enhancement caused a failure, the change management module may forward the file change to a developer for correction. Other manners of facilitating corrections may also be used. At step 410, a change management module may create a trigger file, as described above. The process may move to step 305 and a migration module may determine whether a trigger file exists.

If no failure occurs at step 400, a change management module sends a move notification to appropriate parties. According to an embodiment of the invention, all users of the model or production system may be notified of the migration and the effects of the migration. An acceptance test is performed on the model or production system at step 420. According to an embodiment of the invention, one or more individuals and/or entities that received a notification of the migration of enhancements into the productions system may be responsible for testing the model or production system with the enhancements. Testing may include ensuring that the required features function correctly, that accurate and desired results are obtained, and that requested features have been added.

At step 425, a determination is made of whether the acceptance testing is approved. If the acceptance testing is approved, a change management module receives an approval sign-off at step 430. According to an embodiment of the invention, the change management module receives a request for service (RFS) sign off, where the individual(s) and/or entities perform acceptance testing by referring to the RFS upon which the enhancements were based. Other bases for acceptance testing, as well as confirming the acceptance testing, may also be used.

At step 435, a determination is made of whether to put the model changes or the enhancements into the production system. If migration to a production system is desired, the change management module creates a batch trigger file which repeats the steps utilized to migrate the enhancement to the model system. The process may then move to step 300 and repeat the prior steps for migration of the enhancements to a production system. If migration of the enhancements to a production system is not desired (e.g., the enhancement have already been migrated to a production software system), acceptance occurs at the model system at step 445, and the acceptance is communicated to the developer, along with the enhancement, at step 105. If the acceptance testing is not approved at step 425, the developer may receive and correct the enhancements at step 105. Other processes may also be used.

Overall Change Management

A change management process is now described below according to an embodiment of the invention. FIGS. 5 and 6 are a flowchart illustrating steps in a process for managing changes and modifications for a software system in a model environment (also referred to as “change management”) and a production environment. Particularly, the process may comprise the steps of first managing one or more changes in a model software system, correcting all problems identified during the migration of the changes, and then managing the changes in a production software system. While the process illustrated in FIGS. 5 and 6 discloses certain steps performed in a particular order, it should be understood that the present invention may be practiced by adding one or more steps to the process, omitting steps within the process, and/or altering the order in which one or more of the steps are performed.

At step 10, the developer creates one or more enhancements to a software system. The software system may be comprised of one or more program modules within the software system. The enhancements to the software system may be comprised of one or more modifications to one or more existing program modules within the software system, or one or more new program modules to be added to the software system. The modifications may also include changes to existing computer codes within a program module, or within the software system. According to an embodiment of the invention, the one or more enhancements may be developed in response to a function request, such as a request for service (“RFS”). An RFS may include a description of the one or more enhancements, as well as the portions of the software system to be modified. Other types of enhancements may also be used.

A quality assurance module evaluates the one or more enhancements at step 12. The quality assurance module may include one or more quality assurance personnel to review the one or more enhancements to ensure that certain quality requirements are met in the one or more enhancements. The quality requirements may include ensuring the robustness of an enhancement, eliminating errors, ensuring that an enhancement complies with a RFS or other quality requirements.

At step 14, the one or more enhancements and information about the one or more enhancements are received at a change management module. According to an embodiment of the invention, the developer may create an enhancement in response to a request for services (RFS), where the RFS may describe the desired enhancements, the functions to be included, the portions of the software system to be altered and other information. The developer may forward the completed enhancement(s) and the RFS to the change management module. According to an embodiment of the invention, an appropriate party at the change management module may first review the received enhancement(s) and confirm that any specifications in the RFS have been met.

According to an embodiment of the invention, the developer may also create a change management process document(s) to use with the change management process for the one or more enhancements. The change management process document(s) may contain information needed by the change management module to perform its functions. The change management process document(s) may be standard documents (e.g., paper documents) or may be electronic documents (which may be referred to as ECMP). Other manners for receiving the one or more enhancements may also be used.

At step 16, the one or more enhancements are analyzed for conformity with the model software system. According to an embodiment of the invention, analysis of the one or more enhancements may comprise reviewing the RFS, reviewing source control data, reviewing the job control language (“JCL”) such as for launching a particular application within the software system, determining a scheduling for migration of the enhancements, determining a distribution for migration of the one or more enhancements, reviewing operator instructions for the enhancement, and reviewing one or more special instructions for the one or more enhancements.

The step of reviewing the RFS may include reviewing an enhancement to ensure that a plurality of specifications and requirements of an appropriate RFS have been addressed. The step of reviewing source control data may include determining where the source control data is located, a condition of the source control data, and other aspects of the source control data. The step of determining scheduling and distribution for migration may include determining a schedule for migrating the one or more enhancements into a model software system, determining where the enhancement needs to be distributed (e.g., what program module(s) and/or office(s) will receive an enhancement), and/or analyzing a proposed schedule and distribution for migration. Scheduling may also include when an enhancement or application associated with an enhancement, will be activated, or run, and the frequency of activation in a model software system and/or a production software system. Distribution may also refer to the generation and delivery of output or results when the enhancement or application associated with the enhancement is activated. This distribution may be delivered to specified locations and/or individuals for the model software system and/or the production software system. For example, migrating an enhancement into a software system, whether a model software system or a production software system, may require migrating the enhancement in different phases onto portions of the software system located in different areas. Thus, migration may entail a multi-step process of replacing and/or adding to portions of the software system. Each step may have to be performed at one or more physical locations (e.g., a central processing location and a number of data entry locations). A schedule and a distribution for migration, proposed by the developer, for example, may be reviewed to determine its feasibility, as well as how the schedule and distribution interact with the schedules and distributions for other enhancements. Analysis may also include reviewing operator instructions and/or other instructions associated with the enhancement. Other portions of an enhancement may also be analyzed.

At step 18, conflicts within the one or more enhancements, or the program modules associated with the one or more enhancements are updated. According to an embodiment of the invention, an assurance tool may be used to update conflicts due to an enhancement.

At step 20, preparation for migration of enhancements to a model system is performed. Preparation may include consulting the change management process document(s) to ensure that information necessary for the migration of enhancements is available, consulting a production turnover tool, such as PanAPT, and/or consulting an automated production control (“APC”). A production turnover tool may be a source control tool that enables change management personnel to migrate source changes into the model software system and/or the production software system. An APC tool may be used to communicate scheduling requests to personnel responsible for entering the scheduling information into a scheduling system. Other functions may also be included in the preparation for turnover of the changes.

At step 22, migration of the one or more enhancements to the model software system are performed. The migration may be performed in a conventional manner known to those in the art, such as by adding the enhancements to the model software system. According to an embodiment of the invention, during migration, the one or more enhancements, an RFS, conflicts, a change management process document(s), a distribution schedule and/or other information may be reviewed.

At step 24, one or more migration notifications are distributed. The migration notifications may be sent to developers, a quality assurance module, users of the production software system which was changed by the one or more enhancements, users of functions in the production software system which were changed, and others who may be affected by a migration of the one or more enhancements to the production software system. The migration notifications may include indicating when the one or more enhancements were migrated, providing documentation necessary for the migration (e.g., instructions for implementing the enhancement(s), new or updated user manuals, etc.), indicating what portions of the software system will be changed, indicating how any functionality was changed, and other information.

A quality assurance module signs-off on the enhancements at step 26. The quality assurance module may include one or more quality assurance personnel to review the enhancements to ensure that certain requirements are met in the enhancements, such as reviewing a RFS. The quality assurance module may also review the migration to the model system to ensure that the proper changes were made and to determine what, if any, problems exist. The quality requirements may include ensuring the robustness of the enhancements, eliminating any errors and problems, or dealing with other quality requirements. Signing-off on these quality requirements may include indicating that the quality requirements have been met. At step 28, a sign-off by the quality assurance module is received by a change management module. According to an embodiment of the invention, the change management module may be the same change management module as discussed in step 14 above.

At step 30, the one or more enhancements to the production software system are analyzed to ensure conformity with the production software system. According to an embodiment of the invention, analysis of the enhancements and changes may comprise reviewing the RFS, reviewing source control data, reviewing the JCL, determining a schedule for migration of the enhancements and changes, determining a distribution of the one or more of the enhancements, reviewing operator instructions for the enhancements, and reviewing one or more special instructions for the enhancements.

As described above with regard to the model software system, reviewing an RFS may include reviewing an enhancement to ensure that it meets the specifications and requirements of an appropriate RFS. Reviewing source control data may include determining the location of the source control data, the condition of the source control data, and other aspects of the control source data. Determining scheduling and distribution may include determining the schedule for migrating the enhancement into a production software system, determining where the enhancement needs to be distributed, and/or analyzing a proposed schedule and distribution for migration. Scheduling may also include determining when an enhancement or application associated with an enhancement will be activated, or run, and the frequency of activation in a model software system and/or a production software system. Distribution may also refer to the generation and delivery of output or results when the enhancement or application associated with the enhancement is activated. This distribution may be delivered to specified locations and/or individuals for the model software system and/or the production software system. As described above, migrating an enhancement into a software system, whether the software system is a model software system or a production software system, may require migrating the enhancement in different phases onto portions of the software system located in different areas. Thus, migration may entail a multi-step process of replacing and/or adding to portions of the software system. Each step then has to be performed at one or more physical locations (e.g., a central processing location and a number of data entry locations). A schedule and distribution for migration, proposed by the developer, for example, may be reviewed to determine feasibility of the schedule and distribution, as well as how the schedule and distribution interact with the schedules and distributions for other enhancements. Analysis may also include reviewing operator instructions and/or other instructions associated with the enhancement. Other portions of an enhancement may also be analyzed.

At step 32, conflicts within the one or more enhancements and the program modules in the production software system are resolved. According to an embodiment of the invention, as with migration to a model software system, an assurance tool may be used to resolve conflicts in code of a source control data in a migration to a production software system. The assurance tool and the process for using the assurance tool will be described in greater detail below.

At step 34, preparation for migration of enhancements to a production software system is performed. Preparation may include consulting an ECMP document to ensure that information necessary for the migration of enhancements is available, consulting PanAPT, and/or consulting APC. Other functions may also be included in preparing for turnover of the changes.

At step 36, the migration of the one or more enhancements to the production software system is performed. The migration may be performed in a conventional manner known to those in the art, such as by adding the enhancements to the production software system. According to an embodiment of the invention, during migration of the one or more enhancements, an RFS, conflicts on the ECMP document, a distribution schedule and/or other information may be reviewed.

At step 38, one or more migration notifications are distributed. The migration notification(s) may be sent to developers, quality assurance users of the production software system which was changed by the one or more enhancements, users of any function in the production software system which was changed, and others who may be affected by the migration of one or more enhancements to the production software system. The migration notification may include indicating when one or more enhancements were made, providing documentation necessary for the migration (e.g., instructions for implementing the enhancement(s), new or updated user manuals, etc.), indicating what portions of a system were changed, indicating how functionality was changed, and other information.

At step 40, warranty placement is performed. The warranty placement may indicate that an enhancement has been moved to the production software system and is under warranty for a specified time period (e.g., thirty days, three months, one year, etc.) in the event a defect occurs. The warranty placement may be a status indicator in the production software system, where the warranty placement (or WP) indicates that the warranty is still in effect, while complete (or CP) indicates that the specified time period has expired and the status of the change is complete.

According to an embodiment of the invention, a change management process may provide for migration of enhancements and changes (via migration of software code within a production software system, for example) in two phases. The first phase may provide for a “dress-rehearsal” migration of one or more enhancements to a model software system. Various modules (e.g., the change management module, the quality assurance module, etc.) within the change management process may review the migration to the model software system to ensure that the migration of the one or more enhancements is properly performed. Any problems or issues that arise during migration to the model software system may then be addressed by the modules. With these systems problems or issues addressed, the second may provide for real implementation of the enhancements or changes on to a production system.

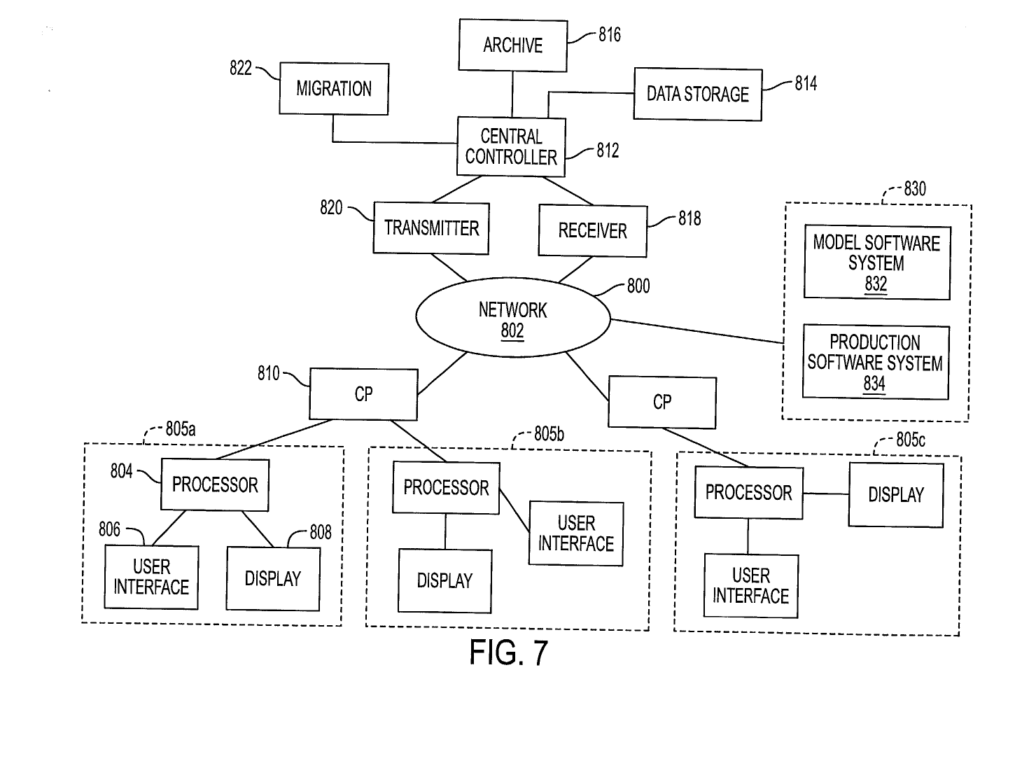

FIG. 7 illustrates a system 800 according to an embodiment of the present invention. The system 800 comprises multiple computer devices 805 (or “computers”) used by a plurality of users to connect to a network 802 through multiple connector providers (CPs) 810. The network 802 may be any network that permits multiple computers to connect and interact. According to an embodiment of the invention, the network 802 may be comprised of a dedicated line to connect the plurality of the users, such as the Internet, an intranet, a local area network (LAN), a wide area network (WAN), a wireless network, or other type of network. The CP 810 may be a provider that connects the users to the network 802. For example, the CP 810 may be an Internet service provider (ISP), a dial-up access means, such as a modem, or other manner of connecting to the network 802. In actual practice, there may be significantly more users connected to the system 800 than shown in FIG. 7. This would mean that there would be additional users who are connected through the same CPs shown or through another CP 800. Nevertheless, for purposes of illustration, the discussion will presume three computer devices 805 are connected to the network 802 through two CPs 810. Additionally, a software system 830 may be connected to the network 802. According to an embodiment of the invention, a software system may have a model software component 832, and a production software system component 834. According to another embodiment of the invention, a model software system and a production software system may be at separate locations.

According to an embodiment of the invention, computer devices 805a-805c may each make use of any device (e.g., a computer, a wireless telephone, a personal digital assistant, etc.) capable of accessing the network 802 through the CP 810. Alternatively, some or all of the computer devices 805a-805c may access the Network 802 through a direct connection, such as a T1 line, or similar connection. FIG. 7 shows the three computer devices 805a-805c, each having a connection to the network 802 through a CP 810a and 810b. The computer devices 805a-805c may each make use of a personal computer such as a computer located in the requester's home, or may use other devices which allow the requester to access and interact with others on the network 802. Central controller module 812 may also have a connection to the network 802 as described above. The central controller module 812 may communicate with one or more data storage modules 814, one or more archive modules 816, and/or one or more migration modules 822 discussed in more detail below.

Each of the computer devices 805a-805c used may contain a processor module 804, a display module 808, and the user interface module 306. Each of the computer devices 805a-805c may have at least one user interface module 806 for interacting and controlling the computer. The user interface module 806 may be comprised of one or more of a keyboard, a joystick, a touchpad, a mouse, a scanner or any similar device or combination of devices. Each of the computers 805a-805c may also include a display module 808, such as a CRT display or other device. According to an embodiment of the invention, a developer, a user of the production system 834, and/or a change management module may use a computer device 805.

The system 800 further includes the central controller module 812. The central controller module 812 may maintain a connection to the network 802 such as through a transmitter module 818 and a receiver module 820. The transmitter module 818 and the receiver module 820 may be comprised of conventional devices which enable the central controller module 812 to interact with the network 802. According to an embodiment of the invention, the transmitter module 818 and the receiver module 820 may be integral with the central controller module 812. According to another embodiment of the invention, the transmitter module 818 and the receiver module 820 may be portions of one connection device. The connection to the network 802 by the central controller module 812 and computers 805 may be a high speed, large bandwidth connection, such as though a T1 or a T3 line, a cable connection, a telephone line connection, a DSL connection, or other type of connection. The central controller module 812 functions to permit the computer devices 805a-805c to interact with each other in connection with various applications, messaging services and other services which may be provided through the system 800.

The central controller module 812 preferably comprises either a single server computer or a plurality of multiple server computers configured to appear to the computer devices 805a-805c as a single resource. The central controller module 812 communicates with a number of data the storage modules 814. Each of the data storage modules 814 stores a plurality of digital files. According to an embodiment of the invention, any of the data storage modules 814 may be located on one or more data storage devices, where the data storage devices are combined or separate from the controller module 812.

One or more modules 816 may be used to archive copies of a model or production software system. As described above, the archive copies may be back-ups for later restoration of the system. A migration module 822 may direct the migration of one or more enhancements into a model or production software system. According to an embodiment of the invention, the migration module 822 may direct a rollback process for removing one or more enhancement from a model or production system.

While the system 800 of FIG. 11 discloses the requester device 805 connected to the network 802, it should be understood that a personal digital assistant (“PDA”), a mobile telephone, a television, or another device that permits access to the network 802 may be used to arrive at the system of the present invention.

According to another embodiment of the invention, a computer-usable and writeable medium having a plurality of computer readable program code stored therein may be provided for practicing the process of the present invention. The process and system of the present invention may be implemented within a variety of operating systems, such as a Windows® operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of the system 800 may comprise computer readable program code in the form of functional instructions stored in the computer-usable medium such that when the computer-usable medium is installed on the system 800, those components cause the system 800 to perform the functions described. The computer readable program code for the present invention may also be bundled with other computer readable program software.

According to one embodiment, the central controller module 812, the data storage 814, the processor module 816, the receiver module 818, and the transmitter module 820 may comprise computer-readable code that, when installed on a computer, perform the functions described above. Also, only some of the components may be provided in computer-readable code.

Additionally, various entities and combinations of entities may employ a computer to implement the components performing the above described functions. According to an embodiment of the invention, the computer may be a standard computer comprising an input device, an output device, a processor device, and data storage device. According to other embodiments of the invention, various components may be different department computers within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, the system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A process for migrating one or more enhancements into a system, where the system comprises one or more program modules and where an enhancement comprises at least one of modifying one or more program modules and adding one or more program modules, the process comprising the steps of:
receiving one or more enhancements from a developer;
generating at least one trigger file associated with the one or more enhancements, where the at least one trigger file is generated based on information associated with the one or more enhancements and the trigger file includes instructions for migrating the enhancements and the one or more enhancements;
migrating the one or more enhancements into the system based at least in part on the generated at least one trigger file; and
receiving an indication of whether the step of migrating the one or more enhancements was successful.

2. The process according to claim 1, where a trigger file is generated for each enhancement.

3. The process according to claim 1, further comprising the step of archiving a copy of at least a portion of the system, where the at least a portion of the system includes a portion of the system to be modified by the at least one enhancement.

4. The process according to claim 3, where, if the received indication indicates that the migration of the one or more enhancements was not successful, the process further comprises the steps of:
reversing the migration of the one or more enhancements into the system; and
reinstalling the archived copy of at least a portion of the system into the system.

5. The process according to claim 1, where, if the received indication indicates that the migration of the one or more enhancements was not successful, the process further comprising the steps of:
returning the one or more enhancements to the developer for correction;
receiving the one or more corrected enhancements from the developer;
generating a new trigger file associated with the one or more corrected enhancements;
migrating the one or more corrected enhancement into the system based at least in part on the generated at least one new trigger file; and
receiving an indication of whether the step of migrating the one or more corrected enhancement was successful.

6. The process according to claim 1, where, if the received indication indicates that the migration of the one or more enhancements was successful, the process further comprises the steps of:
notifying one or more designated individuals about the successful migration of the one or more enhancements;
conducting an acceptance test on the one or more enhancements by the one or more designated individuals; and
receiving a second indication of the acceptance test from at least one of the one or more designated individuals.

7. The process according to claim 6, where, if the received second indication indicates that the acceptance test was successful, the process further comprises the step of notifying the one or more designated individuals that the model or production system is available for production use.

8. The process according to claim 6, where, if the received second indication indicates that the acceptance test was unsuccessful, the process further comprises the steps of:
returning the one or more enhancements to the developer for correction;
receiving the one or more corrected enhancements from the developer;
generating a new trigger file associated with the one or more corrected enhancements;
migrating the one or more corrected enhancement into the system based at least in part on the generated at least one new trigger file; and
receiving an indication of whether the step of migrating the one or more corrected enhancement was successful.

9. The process according to claim 6, further comprising the step of archiving a copy of at least a portion of the system, where the at least a portion of the system includes the portion of the system to be modified by the at least one enhancement.

10. The process according to claim 9, where, if the received second indication indicates that the migration of the one or more enhancements was not successful, the process further comprises the steps of:
reversing the migration of the one or more enhancements into the system; and
reinstalling the archived copy of at least a portion of the system into the system.

11. A process for migrating one or more enhancements into a system, where the system comprises one or more program modules and where an enhancement comprises at least one of modifying one or more program modules and adding one or more program modules, the process comprising the steps of:
receiving one or more enhancements from a developer;
generating at least one trigger file to be associated with each of the one or more enhancements, where the at least one trigger file is generated based on the information associated with the one or more enhancements and the trigger file includes instructions for migrating the enhancements and the one or more enhancements;
archiving a copy of at least a portion of the system, where the at least a portion of the system includes the portion of the system to be modified by the at least one enhancement;
migrating the one or more enhancements into the system based at least in part on the generated at least one trigger file; and
receiving an indication of whether the step of migrating the one or more enhancements was successful.

12. The process according to claim 11, where, if the received indication indicates that the migration of the one or more enhancements was not successful, the process further comprises the steps of:
reversing the migration of the one or more enhancements into the system; and
reinstalling the archived copy of at least a portion of the system into the system.

13. The process according to claim 11, where, if the received indication indicates that the migration of the one or more enhancements was not successful, the process further comprises the steps of:
returning the one or more enhancements to the developer for correction;
receiving the one or more corrected enhancements from the developer;
generating a new trigger file associated with the one or more corrected enhancements;
migrating the one or more corrected enhancement into the system based at least in part on the generated at least one new trigger file; and
receiving an indication of whether the step of migrating the one or more corrected enhancement was successful.

14. The process according to claim 11, where, if the received indication indicates that the migration of the one or more enhancements was successful, the process further comprises the steps of:
notifying one or more designated individuals about the successful migration of the one or more enhancements;
conducting an acceptance test on the one or more enhancements by the one or more designated individuals; and
receiving a second indication of whether the acceptance test was successful from at least one of the one or more designated individuals.

15. The process according to claim 14, where, if the received second indication indicates that the acceptance test was successful, the process further comprises the step of notifying one or more designated individuals that the production system is available for production use.

16. The process according to claim 14, where, if the received second indication indicates that the acceptance test was unsuccessful, the process further comprises the steps of:
returning the one or more enhancements to the developer for correction;
receiving the one or more corrected enhancements from the developer;
generating a new trigger file associated with the one or more corrected enhancements;
migrating the one or more corrected enhancement into the system based at least in part on the generated at least one new trigger file; and
receiving an indication of whether the step of migrating the one or more corrected enhancement was successful.

17. The process according to claim 14, where, if the received second indication indicates that the migration of the one or more enhancements was not successful, the process further comprises the steps of:
reversing the migration of the one or more enhancements into the system; and
reinstalling the archived copy of at least a portion of the system into the system.

18. A system for migrating one or more enhancements into a production system, where the production system comprises one or more program modules and where an enhancement comprises at least one of modifying one or more program modules and adding one or more program modules, the system comprising:
a receiver module for receiving one or more enhancements from a developer;
a processor module for generating at least one trigger file associated with the one or more enhancements, where the at least one trigger file is generated based on the information associated with the one or more enhancements and the trigger file includes instructions for migrating the enhancements and the one or more enhancements;
a migration module for migrating the one or more enhancements into the system based at least in part on the generated at least one trigger file; and
where the receiver module receives an indication of whether the migrating of the one or more enhancements was successful.

19. The system according to claim 18, where a trigger file is generated for each enhancement.

20. The system according to claim 18, further comprising an archive module for archiving a copy of at least a portion of the system, where the at least a portion of the system includes a portion of the system to be modified by the at least one enhancement.

21. The system according to claim 20, where, if the received indication indicates that the migration of the one or more enhancements was not successful,:
the migration module reverses the migration of the one or more enhancements into the system; and
the archive module reinstalls the archived copy of at least a portion of the system into the system.

22. The system according to claim 18, where, if the received indication indicates that the migration of the one or more enhancements was not successful, the system further comprises a transmitter module for returning the one or more enhancements to the developer for correction, and
the receiver module receives the one or more corrected enhancements from the developer;
the processor module generates a new trigger file associated with the one or more corrected enhancements;
the migration modules migrates the one or more corrected enhancement into the system based at least in part on the generated at least one new trigger file; and
the receiver module receives an indication of whether the migrating of the one or more corrected enhancements was successful.

23. The system according to claim 18, where, if the received indication indicates that the migration of the one or more enhancements was successful, the system further comprises
a transmitter module for notifying one or more designated individuals about the successful migration of the one or more enhancements;
an acceptance testing module for conducting an acceptance test on the one or more enhancements;
wherein the receiver module receives a second indication of whether the acceptance test was successful from at least one of the one or more designated individuals.

24. The system according to claim 23, where, if the received second indication indicates that the acceptance test was successful, the transmitter module notifies one or more designated individuals that the production systems is available for production use.

25. The system according to claim 23, where, if the received second indication indicates that the acceptance test was unsuccessful, the system further comprises a transmitter module for returning the one or more enhancements to the developer for correction, and wherein:
the receiver module receives the one or more corrected enhancements from the developer;
the processor module generates a new trigger file associated with the one or more corrected enhancements;
the migrating module migrates the one or more corrected enhancement into the system based at least in part on the generated at least one new trigger file; and
the receiver module receives an indication of whether the migrating of the one or more corrected enhancements was successful.

26. The system according to claim 23, further comprising the step of archiving a copy of at least a portion of the system, wherein the at least a portion of the system includes a portion of the system to be modified by the at least one enhancement.

27. The system according to claim 26, where, if the received second indication indicates that the migration of the one or more enhancements was not successful, the system further comprises:
the migration module reverses the migration of the one or more enhancements into the system; and
the archive module reinstalls the archived copy of at least a portion of the system into the system.

28. A system for migrating one or more enhancements into a production system, where the production system comprises one or more program modules and where an enhancement comprises at least one of modifying one or more program modules and adding one or more program modules, the system comprising:
a receiver module for receiving one or more enhancements from a developer;
a processor module for generating at least one trigger file to be associated with each of the one or more enhancements, where the at least one trigger file is generated based on information associated with the one or more enhancements and the trigger file includes instructions for migrating the enhancements and the one or more enhancements;
an archiving module for archiving a copy of at least a portion of the system, where the at least a portion of the system includes a portion of the system to be modified by the at least one enhancement;
a migration module for migrating the one or more enhancements into the system based at least in part on the generated at least one trigger file; and
wherein the receiver module receives an indication of whether the migrating of the one or more enhancements was successful.

29. The system according to claim 28, where, if the received indication indicates that the migration of the one or more enhancements was not successful,
the migration module reverses the migration of the one or more enhancements into the system; and
the archive module reinstalls the archived copy of at least a portion of the system into the system.

30. The system according to claim 28, where, if the received indication indicates that the migration of the one or more enhancements was not successful, the system further comprises a transmitter module for returning the one or more enhancements to the developer for correction, and wherein:
the receiver module receives the one or more corrected enhancements from the developer;
the processor module generates a new trigger file associated with the one or more corrected enhancements;
the migration module migrates the one or more corrected enhancement into the system based at least in part on the generated at least one new trigger file; and
the receiver module receives an indication of whether the migrating of the one or more corrected enhancements was successful.

31. The system according to claim 28, where, if the received indication indicates that the migration of the one or more enhancements was successful, the system further comprises a transmitter module for notifying one or more designated individuals about the successful migration of the one or more enhancements;
an acceptance testing module for conducting an acceptance test on one or more enhancements; and
wherein the receiver module receives a second indication of whether the acceptance test was successful from at least one of the one or more designated individuals.

32. The system according to claim 31, where, if the received second indication indicates that the acceptance test was successful, the transmitter module further notifies one or more designated individuals that the production system is available for production use.

33. The system according to claim 31, where, if the received second indication indicates that the acceptance test was unsuccessful,
the transmitter module returns the one or more enhancements to the developer for correction;
the receiver module receives the one or more corrected enhancements from the developer;
the processor module generates a new trigger file associated with the one or more corrected enhancements;
the migration module migrates the one or more corrected enhancement into the system based at least in part on the generated at least one new trigger file; and
the receiver module receives an indication of whether the migrating of the one or more corrected enhancements was successful.

34. The system according to claim 28, where, if the received second indication indicates that the migration of the one or more enhancements was not successful,
the migration module reverses the migration of the one or more enhancements into the system; and
the archive module reinstalls the archived copy of at least a portion of the system into the system.
